(19) United States
(12) Patent Application Publication
(10) Pub. No.: US 2004/0021352 A1
(43) Pub. Date: Feb. 5, 2004

(54) Motorcycle heat deflector

(75) Inventor: Joseph Montone, Cedar Knolls, NJ (US)

Correspondence Address: KENYON & KENYON, ONE BROADWAY, NEW YORK, NY, 10004, US

(73) Assignee: Cool Balz

(21) Appl. No.: 10/211,667

(22) Filed: Aug. 2, 2002

(51) Int. Cl. B62J 1/00

(52) U.S. Cl. 297/219.11

(57) ABSTRACT

A heat deflector for use in connection with an engine of a motorcycle is provided, which heat deflector is in the form of a seat cover and includes a flexible mat configured to rest atop the seat of the motorcycle and a securing arrangement fixedly secured to the flexible mat, the securing arrangement configured to secure the seat cover to the motorcycle, in which the flexible mat deflects heat generated from engine components and oil reservoir of the motorcycle away from a rider while operating the motorcycle.

### FIELD OF THE INVENTION

The present invention relates to a heat deflector in the form of a seat cover for use in connection with a motorcycle.

### BACKGROUND INFORMATION

When riding a motorcycle, a rider may experience discomfort from heat generated by engine components of the motorcycle, which may be situated in close proximity to the rider. Presently, there is no satisfactory solution for protecting a motorcycle rider's body from the heat generated by the motorcycle engine and/or oil reservoir. While several prior art references mention heat shields or cover structures for motorcycles, (see, e.g., U.S. Pat. Nos. 4,023,821; 4,685,530; 4,441,574; 4,283,084; 6,179,313), none of these references address the problem of protecting the motorcycle rider's body from the heat generated by the motorcycle engine and/or oil reservoir.

### SUMMARY OF THE INVENTION

An object of the present invention is to provide a heat deflector in the form of a seat cover for a seat of a motorcycle, which seat cover includes a flexible mat configured to rest atop the seat of the motorcycle and a securing arrangement fixedly secured to the flexible mat. The securing arrangement is configured to secure the seat cover to the motorcycle, whereby the flexible mat deflects heat generated from engine components and oil reservoir of the motorcycle away from a rider while operating the motorcycle.

Another object of the present invention is to provide the seat cover described above, in which the flexible mat includes a first bulge portion and a second bulge portion, the first bulge portion and the second bulge portion extending downward on each side of the motorcycle. Still another object of the present invention is to provide the seat cover described above, in which each of the bulge portions is substantially disk-shaped and has a diameter of approximately 11.25 inches and a radial length of approximately 16.75 inches.

Yet another object of the present invention is to provide the seat cover described above, in which the flexible mat includes a binding secured to the flexible mat by at least one of sewing and an adhesive.

Still another object of the present invention is to provide the seat cover described above, in which the securing arrangement includes at least one of a belt/belt-buckle securing arrangement, a hook/eye-ring securing arrangement, a clasp securing arrangement, a latch securing arrangement, a bungee-cord securing arrangement, and a strap/D-ring securing arrangement.

Yet another object of the present invention is to provide the seat cover described above, in which the securing arrangement includes a first securing arrangement and a second securing arrangement.

Still another object of the present invention is to provide the seat cover described above, in which each of the first and second securing arrangements includes at least one of a belt/belt-buckle securing arrangement, a hook/eye-ring securing arrangement, a clasp securing arrangement, a latch securing arrangement, a bungee-cord securing arrangement, and a strap/D-ring securing arrangement.

Yet another object of the present invention is to provide a seat cover for a seat of a motorcycle, including a flexible mat configured to rest atop the seat of the motorcycle, the flexible mat including a first bulge portion and a second bulge portion, the first bulge portion and the second bulge portion extending downward on each side of the motorcycle, a first securing arrangement fixedly secured to the flexible mat, the first securing arrangement configured to secure the seat cover to the motorcycle, and a second securing arrangement fixedly secured to the flexible mat, the second securing arrangement configured to secure the seat cover to the motorcycle, in which the flexible mat deflects heat generated from engine components and/or oil reservoir of the motorcycle away from a rider while operating the motorcycle.

### BRIEF DESCRIPTION OF THE DRAWINGS

FIG. 1a illustrates a side view of a motorcycle with an exemplary seat cover according to the present invention.

FIG. 1b illustrates a top view of a motorcycle with an exemplary seat cover according to the present invention.

FIG. 2a illustrates a first exemplary seat cover according to the present invention.

FIG. 2b illustrates the exemplary seat cover of FIG. 2a secured to a seat of a vehicle.

FIG. 2c illustrates in greater detail the exemplary seat cover of FIG. 2a, in which a first securing arrangement includes a belt/belt-buckle securing arrangement and a second securing arrangement includes a hook/eye-ring securing arrangement.

FIG. 2d illustrates a belt for use with a belt/belt-buckle securing arrangement.

FIG. 2e illustrates a fully secured belt/belt-buckle securing arrangement.

FIG. 2f illustrates a fully secured hook/eye-ring securing arrangement.

FIG. 3a illustrates in greater detail the exemplary seat cover of FIG. 2a, in which a first securing arrangement includes a belt/belt-buckle securing arrangement and a second securing arrangement includes a bungee-cord securing arrangement.

FIG. 3b illustrates a fully secured bungee-cord securing arrangement.

FIG. 4a illustrates in greater detail the exemplary seat cover of FIG. 2a, in which a first securing arrangement includes a belt/belt-buckle securing arrangement and a second securing arrangement includes a strap/D-ring securing arrangement.

FIG. 4b illustrates a fully secured strap/D-ring securing arrangement.

### DETAILED DESCRIPTION

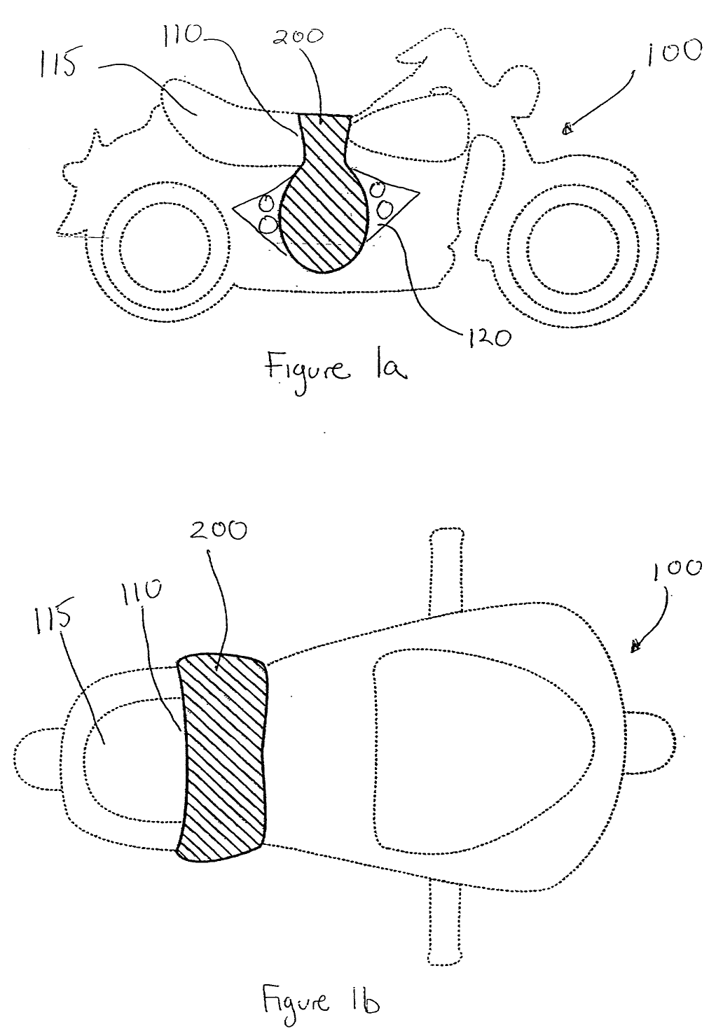

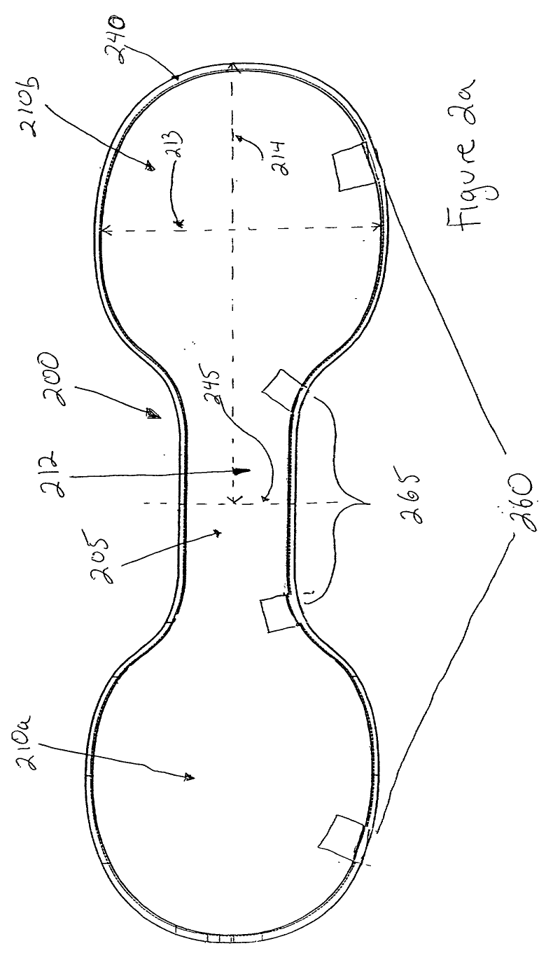

Referring to FIGS. 1a and 1b, a motorcycle 100 is shown with an exemplary heat deflector in the form of a seat cover 200 according to the present invention. Heat deflector (or seat cover) 200 is suitably designed to cover side-mounted engine components 120 (including oil reservoir) and to deflect heat generated from the engine components 120 away from a rider (not shown) while operating the vehicle. The seat cover 200 rests atop a front portion 110 of a seat 115 and extends downward on each side of the motorcycle 100.

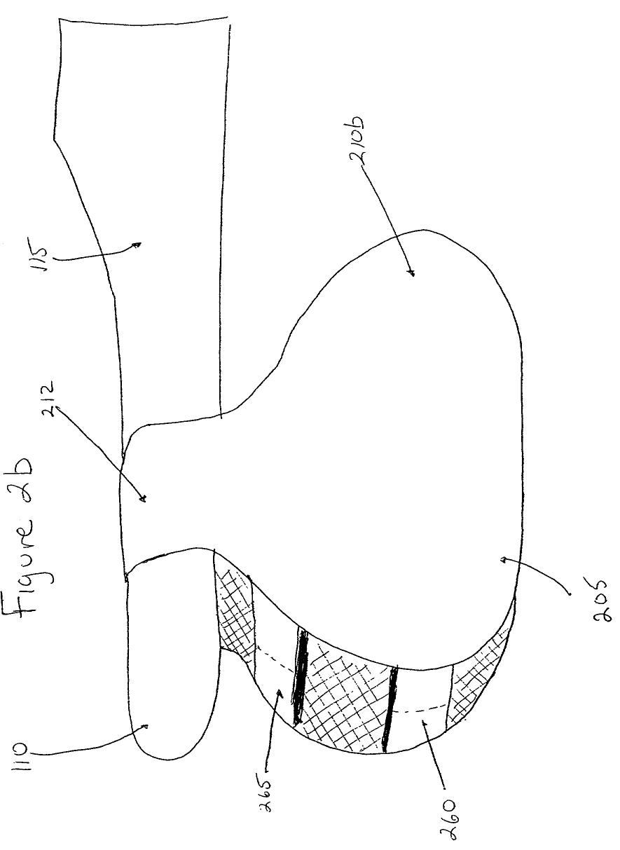

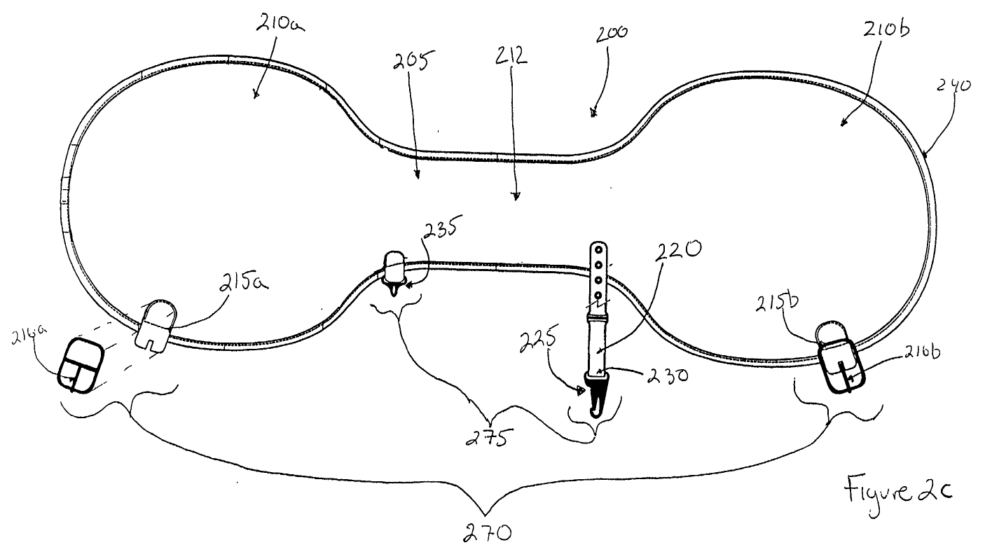

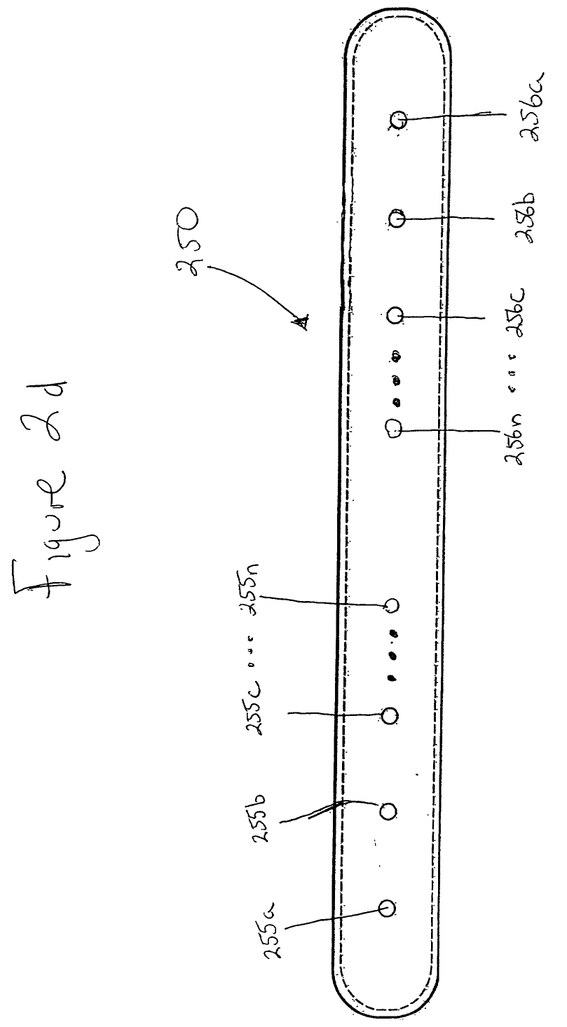

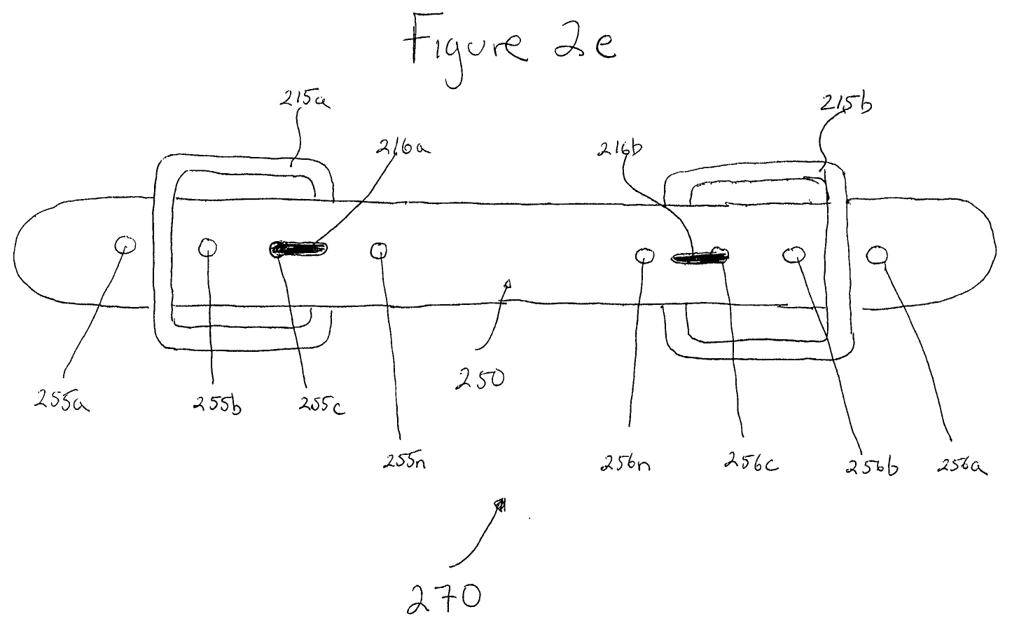

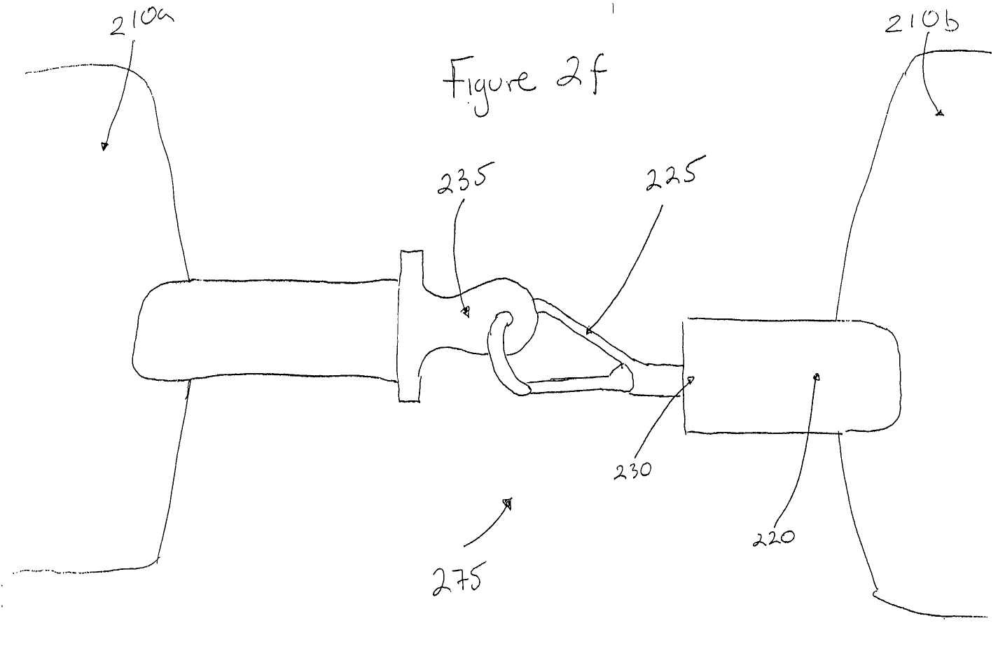

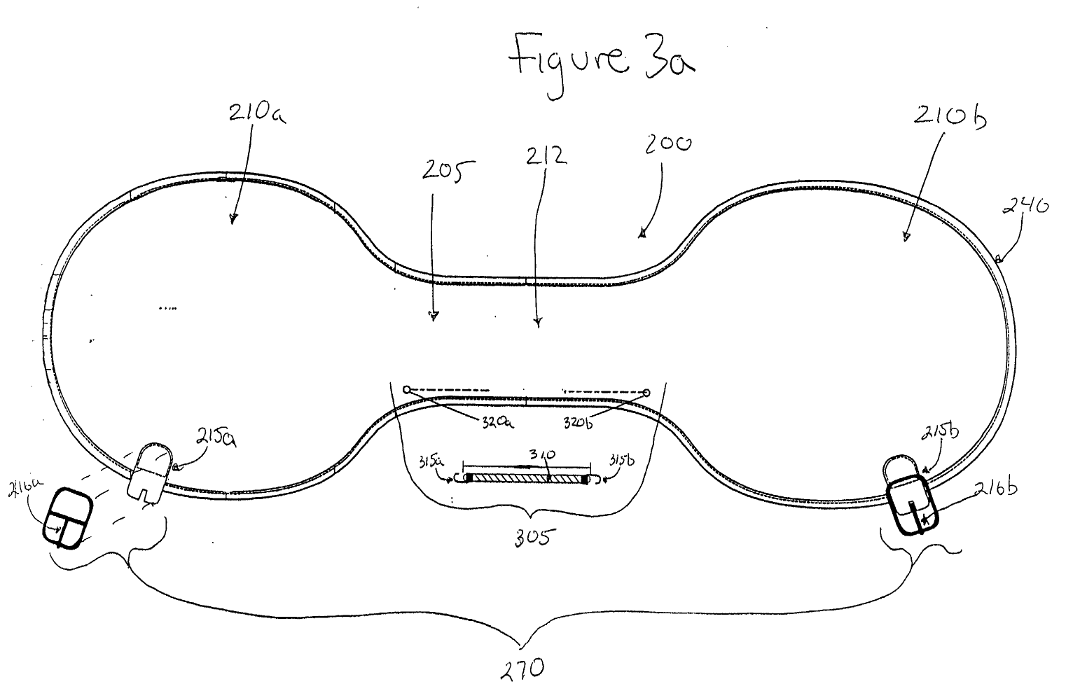

As shown in FIG. 2a, which is a general depiction of a first exemplary seat cover 200 according to the present invention, the seat cover 200 includes a flexible mat 205 having bulge portions 210a, 210b and a center portion 212, a binding 240 fixedly secured to the flexible mat 205, a first securing arrangement 260, and a second securing arrangement 265.

The flexible mat 205 may be constructed from any flexible material suitable for deflecting heat from the rider, for example, leather. Furthermore, the material selected should have sufficient thickness to better facilitate diversion of heat generated by the side-mounted engine components 120, for example, single ply approximately ⅛ inch leather with a full grain or natural finish.

The bulge portions 210a, 210b of the flexible mat 205 may be identically symmetrical about center axis 245, although they need not be. For example, each of the bulge portions 210a, 210b may be substantially disk-shaped, having a diameter 213 of approximately 11.25 inches and a radial length 214 of approximately 16.75 inches, and the center portion 212 may have a width of, for example, approximately 4.5 inches. Notwithstanding, the proportions of the bulge portions 210a, 210b should be sufficiently sized to cover the heat generating side-mounted engine components 120 when the seat cover 200 is mounted to a vehicle, for example, motorcycle 100.

The flexible mat may include the binding 240. The binding 240 may be made of, for example, leather, and be secured to the flexible mat 205, for example, by sewing and/or by an adhesive.

The first securing arrangement 260 and the second securing arrangement 265 are configured to fixedly secure the seat cover 200 to the motorcycle 100, as illustrated in FIG. 2b. Either or both of the first securing arrangement 260 and the second securing arrangement 265 may include, for example, a belt/belt-buckle securing arrangement, a hook/eye-ring securing arrangement, a clasp securing arrangement, a latch securing arrangement, a bungee-cord securing arrangement, a strap/D-ring securing arrangement, etc. Furthermore, it should be appreciated that, although FIG. 2a shows seat cover 200 having two securing arrangements, any number of securing arrangements may be employed to secure the seat cover 200 to the motorcycle 100, for example, one securing arrangement, three securing arrangements, four securing arrangements, etc.

The exemplary seat cover 200 generally shown in FIG. 2a is shown in greater detail in FIGS. 2c and 2d, in which the first securing arrangement 260 includes a belt/belt-buckle securing arrangement 270 and the second securing arrangement 265 includes a hook/eye-ring securing arrangement 275. The belt/belt-buckle securing arrangement 270 includes first and second buckles 215a, 215b having securing pins 216a, 216b, respectively, the first and second buckles 215a, 215b being fixedly secured to the flexible mat 205, and a belt 250 (shown in FIG. 2d) having first holes 255a, 255b, 255c, . . . , 255n for engaging the first buckle 215a and second holes 256a, 256b, 256c, . . . , 256n for engaging the second buckle 215b. The hook/eye-ring securing arrangement 275 includes an adjustable strap 220 fixedly secured to the flexible mat 205, a hook 225 loosely coupled to a distal end 230 of the leather strap 220 and an eye ring 235 fixedly secured to the flexible mat 205.

The first and second buckles 215a, 215b of the belt/belt-buckle securing arrangement 270 may be made from any durable material, such as brushed nickel, steel, plastic, brass, a metal alloy, etc. The first and second buckles 215a, 215b are configured to secure the seat cover 200 to the motorcycle 100 via belt 250. The belt 250 may be made from, for example, leather, and fit under the seat 115 of the motorcycle 100 to couple to the first and second buckles 215a, 215b.

Referring now to FIG. 2e, there is seen a fully secured belt/belt-buckle securing arrangement 270. The securing pin 216a of the first buckle 215a engages in one of the first holes 255a, 255b, 255c, . . . , 255n of the belt 250 and the securing pin 216b of the second buckle 215b engages in one of the second holes 256a, 256b, 256c, . . . , 256n of the belt 250. It should be appreciated that the first and second securing pins 216a, 216b may be engaged in different ones of the first holes 255a, 255b, 255c, . . . , 255n and second holes 256a, 256b, 256c, . . . , 256n to permit the belt 250 to secure the seat cover 200 to different sized motorcycles 100. For example, the first and second securing pins 216a, 216b may engage the first hole 255a and second hole 256a, respectively, to permit the seat cover 200 to be secured to a large motorcycle 100, whereas the first and second securing pins 216a, 216b may engage the first hole 255c and the second hole 256c, respectively, to permit the seat cover 200 to be secured to a small motorcycle 100.

Referring now to FIG. 2f, there is seen a fully secured hook/eye-ring securing arrangement 275. Similar to the belt/belt-buckle securing arrangement 270, the hook/eye-ring securing arrangement 275 is configured to help secure the seat cover 200 to the motorcycle 100. As seen in FIG. 2e, the adjustable strap 220 fits under the seat 115 and secures to the eye ring 235 via hook 225. The adjustable strap 220 may be made from, for example, leather, and may be suitably designed to have an adjustable length, thereby being capable of accommodating various sized motorcycles 100.

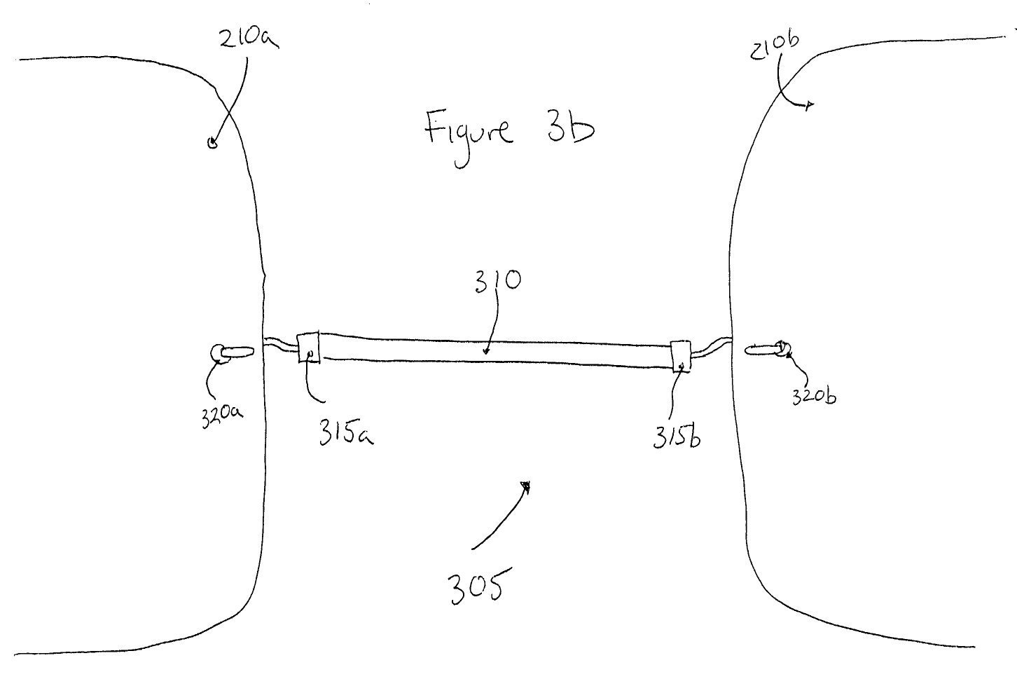

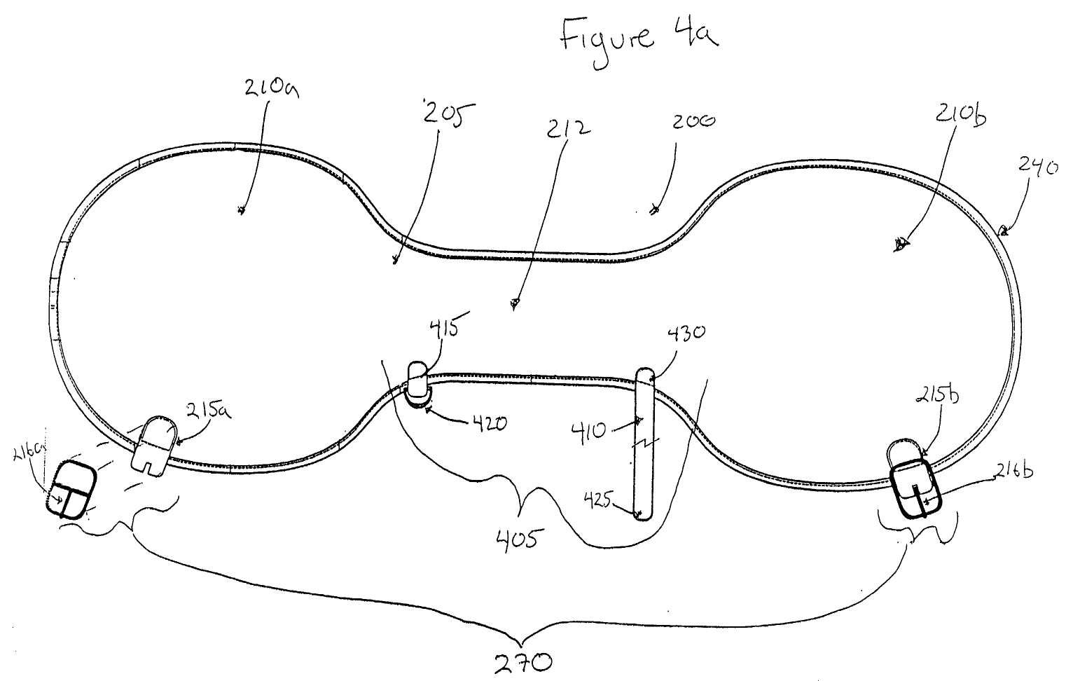

The exemplary seat cover 200 generally shown in FIG. 2a is shown in greater detail in FIG. 3a, in which the first securing arrangement 260 includes a belt/belt-buckle securing arrangement 270 and the second securing arrangement 265 includes a bungee-cord securing arrangement 305. Bungee-cord securing arrangement 305 includes bungee-cord 310 having a first hook 315a and a second hook 315b, and first and second bungee-cord securing holes 320a, 320b penetrating the flexible mat 205. Like the belt/belt-buckle securing arrangement 270 and the hook/eye-ring securing arrangement 275, the bungee-cord securing arrangement 305 is configured to help secure the seat cover 200 to the motorcycle 100.

Referring now to FIG. 3b, there is seen a fully secured bungee-cord securing arrangement 305. The bungee-cord 310 fits under the seat 115 and secures to the first and second bungee-cord securing holes 320a, 320b via first hook 315a and second hook 315b, respectively. The bungee-cord 310 may be made of a spring-like and flexible material, which permits the bungee-cord 310 to be stretched to accommodate various sized motorcycles 100.

Although FIGS. 3a and 3b show the bungee-cord 310 securing to the first and second bungee-cord securing holes 320a, 320b via first hook 315a and second hook 315b, respectively, it should be appreciated that the bungee-cord 310 may secure to another arrangement fixedly coupled to the flexible mat 205, for example, a metal loop, a strap with an attached loop, a mating-hook, etc.

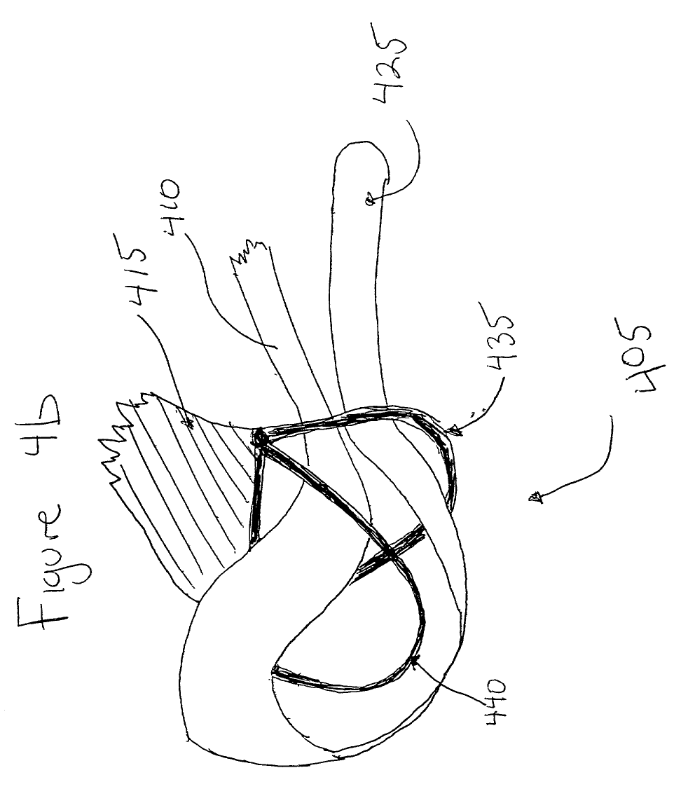

The exemplary seat cover 200 generally shown in FIG. 2a is shown in greater detail in FIG. 4a, in which the first securing arrangement 260 includes a belt/belt-buckle securing arrangement 270 and the second securing arrangement 265 includes a strap/D-ring securing arrangement 405. Strap/D-ring securing arrangement 405 includes a strap 410 with distal end 425 and a proximal end 430, the proximal end 430 of the strap 410 being fixedly secured to the flexible mat 205, a D-ring strap 415 fixedly secured to the flexible mat 205, and at least one D-ring 420 loosely secured to a distal end 425 of the strap 410. The strap/D-ring securing arrangement 405 is provided to help secure the seat cover 200 to the motorcycle 100. For this purpose, strap 410 fits underneath seat 115, with the distal end 425 of the strap 410 fixedly coupling to the at least one D-ring 420. The strap 410 may be made from any flexible and durable material, such as leather, and the at least one D-ring 420 may be made from, for example, brushed nickel, steel, plastic, brass, a metal alloy, etc.

Referring now to FIG. 4b, there is seen a fully secured strap/D-ring securing arrangement 405. As seen in FIG. 4b, the at least one D-ring 425 includes a first D-ring 435 and a second D-ring 440. To fixedly couple strap 410 to the first and second D-rings 435, 440, the distal end 425 of the strap 410 is guided through the first and second D-rings 435, 440 and then back through the first D-ring 435.

Although the present invention has been described in connection with exemplary embodiments, it should be noted that the present invention is not limited to the exemplary embodiments. For example, the material selected for the flexible mat 205 may be any flexible material suitable for deflecting heat from the rider.

What is claimed is:

1. A heat deflector for use in connection with an engine of a motorcycle, comprising:
a flexible mat configured to rest atop a seat of the motorcycle and cover at least a portion of the engine such that the flexible mat is interposed between the engine and a rider; and
a securing arrangement fixedly secured to the flexible mat, the securing arrangement being configured to secure the seat cover to the motorcycle;
wherein the flexible mat deflects heat generated from the engine of the motorcycle away from the rider.

2. The seat cover according to claim 1, wherein the flexible mat also covers at least a portion of an oil reservoir of the motorcycle, and wherein the flexible mat deflects heat from the oil reservoir away from the rider.

3. The seat cover according to claim 2, wherein the flexible mat includes a first bulge portion and a second bulge portion, the first bulge portion and the second bulge portion extending downward on each side of the vehicle.

4. The seat cover according to claim 3, wherein the flexible mat includes leather.

5. The seat cover according to claim 4, wherein the flexible mat is approximately ⅛ inch thick.

6. The seat cover according to claim 5, wherein each of the bulge portions is substantially disk-shaped and has a diameter of approximately one foot and a radial length of approximately 17 inches.

7. The seat cover according to claim 3, wherein the flexible mat includes a binding secured to the flexible mat by at least one of sewing and an adhesive.

8. The seat cover according to claim 1, wherein the securing arrangement includes at least one of a belt/belt-buckle securing arrangement, a hook/eye-ring securing arrangement, a clasp securing arrangement, a latch securing arrangement, a bungee-cord securing arrangement, and a strap/D-ring securing arrangement.

9. The seat cover according to claim 1, wherein the securing arrangement includes a first securing arrangement and a second securing arrangement.

10. The seat cover according to claim 9, wherein each of the first and second securing arrangements includes at least one of a belt/belt-buckle securing arrangement, a hook/eye-ring securing arrangement, a clasp securing arrangement, a latch securing arrangement, a bungee-cord securing arrangement, and a strap/D-ring securing arrangement.

11. The seat cover according to claim 9, wherein the flexible mat includes a first bulge portion and a second bulge portion, the first bulge portion and the second bulge portion extending downward on each side of the vehicle.

12. The seat cover according to claim 9, wherein the flexible mat includes leather.

13. The seat cover according to claim 12, wherein the flexible mat is approximately ⅛ inch thick.

14. The seat cover according to claim 13, wherein each of the bulge portions is substantially disk-shaped and has a diameter of approximately one foot and a radial length of approximately 17 inches.

15. The seat cover according to claim 12, wherein the flexible mat includes a binding secured to the flexible mat by at least one of sewing and an adhesive.
